(19) United States
(12) Patent Application Publication
(10) Pub. No.: US 2008/0095997 A1
(43) Pub. Date: Apr. 24, 2008

(54) Function-Enhancing Optical Film

(76) Inventors: Tien-Hon Chiang, Taipei (TW); Gu-Sheng Yu, Taipei (TW); Hsiang-Hua Wang, Taipei (TW); Wei-Li Chen, Taipei (TW); Hsiao-Yun Lin, Taipei (TW); Yuh-Harn Lin, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/550,799

(22) Filed: Oct. 19, 2006

(51) Int. Cl. B32B 27/30; B32B 5/16; B32B 9/00

(52) U.S. Cl. 428/215; 428/522; 428/331; 428/328; 428/702

(57) ABSTRACT

A multi-function, multi-layer optical film is disclosed herein. The most basic structure of the optical film contains a first hard coat layer on a front surface of a transparent substrate. The first hard coat layer can integrate in itself the anti-glare, anti-smudge, anti-UV, and anti-static functions by blending appropriate amount of specific chemicals into the acrylate resin of the first hard coat layer. The first hard coat layer is made of acrylate resin containing an appropriate amount of polyoxetane polymers with pendant side chain having at least a fluorocarbon (C—F) bond. The constituent fluorine modifies the surface energy of the first hard coat layer so that additional function-enhancing layers can be developed from the front surface of the basic structure reliably.

### BACKGROUND OF THE INVENTION

1. Field of the Invention

The present invention generally relates to optical films for the use of display devices, and more particularly to a film for enhancing multiple physical, mechanical, and optical functions of the display device.

2. The Prior Arts

Visual displays are one of the most important man-machine interfaces and various existing and emerging display technologies such as liquid crystal display (LCD), plasma display, organic light emitting display (OLED) have been disclosed and applied to all sorts of electronic devices around modem people. Conventionally, one or more films or coatings are arranged on the outmost front surface of a display device as a form of surface treatment for improving the physical, mechanical, and/or optical functions of the display device.

For example, an anti-reflection or low reflection coating is disposed on the surface of the display device so that the display device would manifest little reflection of unwanted images from outside sources and to enhance the light transmission performance for brighter display image quality. The anti-reflection or low-reflection coating usually has a layer structure in which, for the purpose of securing sufficient hardness; a hard coat layer is provided on a substrate; and on the hard coat layer a transparent layer is provided having a smaller refractive index than that of the hard coat layer. Alternatively, a number of transparent layers having higher and lower refractive indices (both relative to that of the hard coat layer) are interleaved on the hard coat layer. The thickness of the individual layer is usually designed in accordance with the targeted reflection light (i.e., preferably ¼λ) to optimize the anti-reflection performance. The hard coat layer on the substrate provides the display device additional protection from scratch, abrasion, and any accidental physical damage. The substrate can be for supporting purpose, or can have a special function, such as light polarization discrimination, transmission speed retardation, light diffusing, light focusing, optical medium recording, or medium displaying. It is also quite common to have an anti-glare treatment on the hard coating layer to reduce glaring from the background reflection of the display device. Additional anti-reflection layer on the anti-glare hard coat layer will further eliminate the glaring effect and thereby improve image quality. The anti-glare or anti-glare anti-reflection film is usually formed by coating a special chemical containing resin on a transparent substrate to diffuse the external light causing the glare.

On the other hand, it is well known that Newton ring is an interference pattern caused by the reflection of light between two surfaces—a spherical surface and an adjacent flat surface. The Newton rings can also be generated when a spacing between the optical devices in close contact with each other is less than a certain value. Many anti-Newton ring films have been disclosed to avoid Newton rings by keeping the spacing larger than the certain value or changing the shape of the surface to reduce light interference possibility. There are also demands for an anti-static film so that the display device wouldn't easily attract dust by static electrification to reduce visibility. The anti-static film is usually a conductive layer containing a metal such as silver or a conductive metal oxide such as indium-tin oxide (ITO) directly coated on the surface of the display device by vapor deposition or sputtering technique.

To prevent the surface of the display device or the various films/coatings from receiving scratches by the touch of fingers or by cleaning, a hard coat film has commonly been applied so as to impart the underlying surface with enhanced anti-scratch and anti-abrasion characteristics. The hard coat film is typically obtained by coating a plastic substrate with a thermosetting resin or an ionizing radiation curing resin (such as UV curable resin). Also, in order to prevent the various films/coatings from being degraded or altered by exposure to direct or diffuse UV (ultra-violet) light, some anti-UV films have been developed which incorporate organic UV-absorbing compounds, and some films contain inorganic compounds like metal oxides, such as titanium dioxide (TiO₂), or zinc oxide (ZnO) for filtering a large range of the UV rays.

For simplicity, all these aforementioned films or coatings are referred to as optical films hereinafter throughout this specification. A large number of teachings have already been disclosed for various types of optical films. To name just a few, U.S. Pat. No. 6,696,140 provides an anti-glare film having a light diffusing layer formed of fine particles dispersed in a light-transparent resin. U.S. Pat. No. 6,398,371 provides another anti-glare film having an anti-glare hard coat layer on top of a triacetyle cellulose transparent support (i.e., substrate). U.S. Pat. No. 6,592,950 discloses an anti-Newton ring film having a transparent substrate and a resin layer formed on one or both sides of the substrate, where the resin layer has an ionizing radiation curable resin as a binder and a particulate material dispersed in the binder. U.S. Pat. No. 6,480,250 teaches a multi layer film having a transparent substrate, a hard coat layer, a transparent conductive layer containing particles of at least one of a metal and a metal oxide, and at least one transparent protective layer which has anti-smudge properties, stacked sequentially in the order described.

### SUMMARY OF THE INVENTION

A multi-function, multi-layer optical film is disclosed herein for enhancing the physical, mechanical, and optical performance of a display device. The most basic structure of the optical film contains a first hard coat layer on a front surface of a transparent substrate. The first hard coat layer can integrate in itself the anti-glare, anti-smudge, anti-UV, and anti-static functions by incorporating appropriate amount of specific chemicals into the acrylate resin of the first hard coat layer.

In an alternative embodiment of the present invention, in addition to or instead of integrating multiple enhancing functions in the first hard coat layer, a dedicated anti-glare layer is formed on the front surface of the first hard coat layer. From the anti-glare layer, additional dedicated anti-static layer and low-reflection layer for enhanced anti-reflection capability are sequentially formed. In some embodiments of the present invention, on the back surface of the transparent substrate, a conductive layer for interfacing the optical film with a conductive device for touch panel application, a low-reflection layer, or a second hard coat layer for enhancing hardness or for reducing Newton ring effect can be optionally formed.

One of the major characteristics of the present invention lies in that, in the multi-layer structure, at least some of the functional layers are made of acrylate resin containing an appropriate amount of fluorinated polyoxetane polymers, in particular a polyoxetane polymers with pendant side chain having at least a fluorocarbon (C—F) bond, in addition to their specific chemicals. The constituent fluorinated polymer is adopted, on one hand, to modify the surface energy of the functional layer so that additional function-enhancing layers can be developed reliably, and, on the other hand, to modify the refractive index of the functional layer which is related to the weight percent concentration of fluorine in the functional layer.

Other major characteristics of the present invention are as follows, in the multi-layer structure, (1) there are specific orders in stacking the various functional layers (e.g., the low-reflection layer is in front of the anti-static layer, which in turn is in front of the anti-glare layer); (2) there are specific interrelationships among them in terms of physical properties such as surface energy and refractive index; and (3) there are specific interrelationships among them in terms of mechanical properties especially the thickness (e.g., the thickness of the first hard coat layer is preferably between 0.5% and 5% of the thickness of the transparent substrate).

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic sectional view showing the optical film according to a first embodiment of the present invention.

FIGS. 2a˜2c are schematic sectional views showing the optical films having conducive and/or low-reflection layer on the back surface of the transparent substrate according to alternative embodiments of the present invention.

FIGS. 3a˜3d are schematic sectional views showing the optical films having a second hard coat layer as an anti-Newton Ring layer on the back surface of the transparent substrate according to additional alternative embodiments of the present invention.

FIGS. 4a˜4d are schematic sectional views showing the optical films having separate functional layers on the front surface of the first hard coat layer according to additional alternative embodiments of the present invention.

FIGS. 5a˜5e are schematic sectional views showing the optical films having a low-reflection layer as the topmost layer according to additional alternative embodiments of the present invention.

FIG. 6 is a schematic sectional views showing the optical film having light diffusing and anti-stick functions according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a multi-function, multi-layer optical film for attaching to the front surface of a display device so as to enhance the physical, mechanical, and optical performance of the display device. The optical film can also be attached to the front surface of the backlight module of the display device. In the following, the former application will be described first. For ease of reference, throughout the specification, the terms “front” and “back” are referred relative to the display device for locations farther away and closer from the light source of the display device, respectively. In the accompanied drawings, the display device is omitted for simplicity and the layers of the optical film from back to front are expressed as stacked rectangular blocks from bottom to top. Additionally, all percentages referred in the following are weight percentages (i.e., wt %).

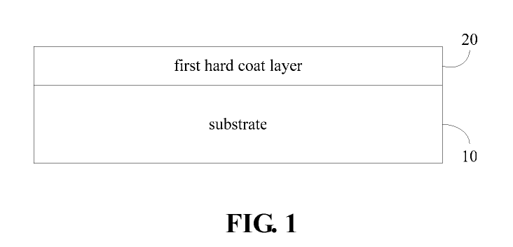

FIG. 1 is a schematic sectional view showing the optical film according to a first embodiment of the present invention, which is also the most basic structure of the present invention. As illustrated, the optical film contains a first hard coat layer 20 on a front surface of a transparent substrate 10. The transparent substrate 10 is usually made of a material such as PET, TAC, PEN, PC, PVC, PMMA, PV, transparent polymer, glass, or a glassy type of composite film. It can simply function as a supporting layer to the other layers of the optical film or, additionally, the transparent substrate 10 itself can be a 3M Vikuiti™ Dual Brightness Enhancement Film (DBEF), a polarization discrimination film, a retardation component, a protection film, a diffuser, a lens, a concentrator, an optical rotator, an optical recording medium, or a display medium. The thickness (T_{SUB}) of the substrate 10 is typically between 10˜10,000 μm, preferably 50˜2,000 μm. In some embodiments of the present invention where additional layers are stacked from the back surface of the transparent substrate 10, the transparent substrate 10 should have an appropriate surface energy (E_{SUB-B}) on its back surface so as to provide appropriate support to these layers. Additionally, the transparent substrate 10 should have an appropriate refractive index (I_{SUB}) so that, together with the additional layers of appropriate refractive indices, the optical film is able to provide the anti-reflection function in some alternative embodiments. More details about these embodiments will be described later.

The first hard coat layer 20 has its back surface interfacing with the front surface of the transparent substrate 10 so as to prevent the transparent substrate 10 from abrasive or scratch damage. The hardness performance is typically over 2 H pencil hardness in accordance with JIS K5400, K5600, or ASTM D3363 standard. The first hard coat layer 20 is formed by wet coating and is made of radiation curable or thermosetting acrylate resin containing at least 0.001˜10% polyoxetane polymers with pendant side chain having 1 to 18, preferably 1 to 4, carbon atoms and at least a fluorocarbon (C—F) bond. UV light curable ionizing radiation curing resin is the most typical resin for this application. The resin also contains 30-60% multi-acrylate monomer and preferably triacrylate monomer, 30-60% urethane acrylate oligomer, and 0.1-5% photo initiator. All the above chemicals are combined to achieve a surface energy (E_{HCl—F}) of 10-50 dyne/cm on the front surface and a refractive index (I_{HCl}) of 1.4˜1.7. The thickness (T_{HCl}) of the first hard coat layer 20 is between 0.05˜500 μm (preferably between 0.1˜10 μm) and should satisfy the equation: 0.0005 T_{SUB}≦T_{HCl}≦0.1 T_{SUB}.

The polyoxetane polymer has a general formula as follows:

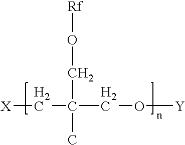

where X and Y represent H, OH, or any hydrocarbon elements, and at least one of the X and Y has (meth)acrylate functionalized group which has one or two or multi-functional (meth)acrylate group. Rf represents a partially fluorinated or perfluorinated group including alkyl, ether bond, ester bond, amide group, or urea group having 1 to 18, preferably 1 to 4, carbon atoms. Also in the formula, n is between 2 to 1000 and 6 to 100 is preferred. Some examples of the polyoxetane polymers represented by the general formula are given below, but it should not be construed that the invention is limited thereto:

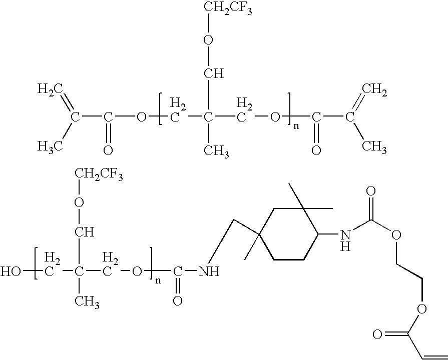

According to experiments, the refractive index of the polyoxetane polymer is reversely and linearly related to the amount of fluorine content. As such, the first hard coat layer 20 can be tuned to a desired refractive index by controlling the amount of the polyoxetane polymer. To enhance the hardness of the first hard coat layer 20 against scratch, the resin can further contain 1˜40% nano particles of silicon oxide, or metal oxide such as titanium oxide and alumina oxide, or both. The particle size is preferably between 0.01˜1 μm.

In addition to the foregoing anti-scratch function, the optical film of FIG. 1 can provide additional enhancement functions by the addition of appropriate components and chemicals. For example, the anti-glare function can be introduced by creating appropriate roughness on the front surface, which prevents user from being glared by scattering light (incident to the front surface of the optical film) toward many directions. According to JIS B0601 (1994), the surface roughness can be defined by the difference of the surface maximum and minimum (Ry) in μm which signifies the interval of peaks and valleys in a selected section of a roughness curve measured in the direction of vertical magnification. The standard length of the selected section is typically 4 mm long. The average surface roughness (Ry) can be obtained by taking the average of 6 data points from 3 different positions along two orthogonal directions. According to the present invention, the average surface roughness (RY_{HCl—F}) of the first hard coat layer 20's front surface is preferably between 0.1˜5 μm and is achieved by adding 1˜40% micro particles of 0.1˜10 μm in diameter to the UV/thermal curable resin. The micro particles are optically transparent polymers or silica base particles, such as silica, PS, PMMA, etc. The thickness of the first hard coat layer 20 should be no more than ⅔ of the largest particle diameter.

One way to ensure the desired anti-glare function of the first hard coat layer 20 is by counting the number of the micro particles within the resin protruding from the front surface in a randomly selected 1-mm² area (D_{HCl—F}). According to the present inventor, D_{HCl—F} should satisfy the equation: 0.1×H_{HCl}×G_{HCl}≦D_{HCl—F}≦100×H_{HCl}×G_{HCl}, where H_{HCl} is the haze in percentage and G_{HCl} is the gloss at 60° in GU (Gloss Unit) of the front surface of the first hard coat layer 20. Gloss is the ability of a surface to reflect light without scattering, and is measured by directing a constant power light beam at an angle to the test surface and then by monitoring the amount of reflected light. Typically speaking, the higher the gloss at 60° is, the lower the average surface roughness (Ry) is. On the other hand, some surfaces appear to have considerable difference in gloss yet give comparable readings when measured with a glossmeter at one angle. These surfaces can be separated by their respective hazes by measuring at a second angle and comparing the difference of the two readings. ASTM D4039 defines haze as the difference between the gloss at 60° and the gloss at 20°.

Anti-smudge function can also be integrated into the first hard coat layer 20 to help preventing the optical film from exposure to skin oils, cosmetics, stains, inks, adventitious dirt, etc., and to help making the optical film easier to clean. As mentioned earlier, the resin of the first hard coat layer 20 contains at least 0.001˜10% polyoxetane polymers. To integrate the anti-smudge function, the amount of the polyoxetane polymers should be at least 0.1% and at least 0.01˜10% siloxane polymers such as polydimethylsiloxane (PDMS) is added to the resin so as to help leveling the resin during the coating and to reduce the surface energy (E_{HCl}) of the first hard coat layer 20 for at least 5 dyne/cm.

It is well known that an object exposed to UV light (wavelength 280-400 nm) for an extended period of time would become yellowed or deformed or even cracked. To prevent UV deterioration, one of two mechanisms, namely the UV absorption and the UV scattering, is usually adopted. For the optically transparent applications such as the present invention, the UV absorption is more favorable, which transforms the absorbed UV light into heat and dispels the heat through cooling. To integrate the UV absorption function into the optical film, 0.01˜5% organic and/or inorganic UV absorbers can be added to the resin of the first hard coat layer 20. Oxalanilide derivatives, benzotriazole derivatives, benzophenone derivatives, and triazine derivatives are typical examples of organic UV absorbers. On the other hand, metal oxides such as ZnO, TiO₂, and Al₂O₃ are typical inorganic UV absorbers. Metal oxide additives are generally more stable in the long run, but at the cost of inferior optical transparency.

To prevent dust from being attracted to the optical film and thereby affecting the visibility of the display device, the anti-static function can be integrated into the first hard coat layer 20 so as to reduce the surface resistivity to be at least less than 10¹² Ω/□ (ohm per square), preferably 10¹⁰ Ω/□. Ohm per square is a unit of resistivity for surface films whose thicknesses are considered to be negligible. The resistivity of a very thin conductor is defined to be its resistance (in ohms) multiplied by its width and divided by its length. If the conductor is square in shape, then its length and width are the same and its resistivity is numerically equal to the resistance of the square, which is actually the same no matter what the size of the square is. Therefore the resistivity could be stated in ohms, but it is conventional to state it in “ohms per square.” One can consider the square to have sides equal to one unit, and the size of the unit being immaterial. To realize the anti-static function, 1˜30% of at least one of a conductive polymer and a conductive inorganic element can be added into the resin of the first hard coat layer 20. The conductive polymer can be polyacetylene, polythiophene, polyphenylene, polypyrrole, polyparaphenylene, polyparaphenylene vinylene, pyrolytic polymers, polypolyaniline, etc. Some examples of the inorganic element are indium tin oxide (ITO), indium zinc oxide (IZO), antimony tin oxide (ATO), Al₂O₃, TiO₂, and Fe₂O₃.

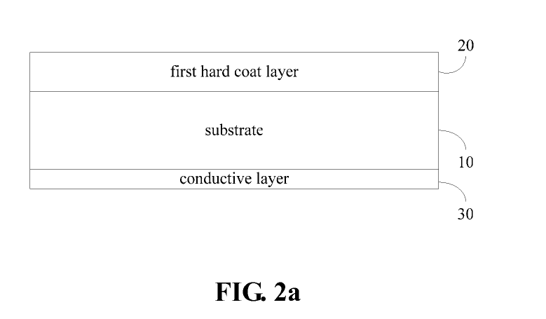

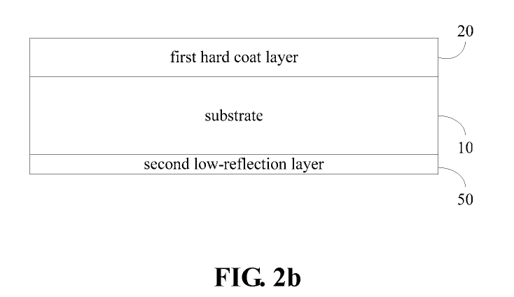

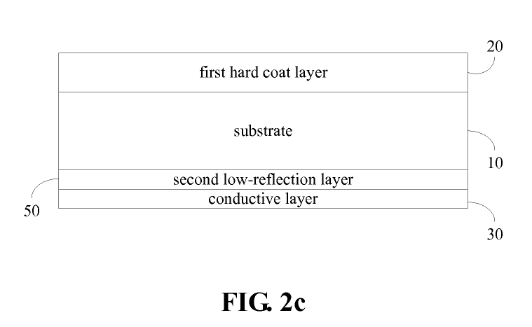

As shown in FIG. 2a, which is a schematic sectional view showing the optical film according to a second embodiment of the present invention, a conductive layer 30 is attached to the back surface of the transparent substrate 10. The purpose of having this conductive layer 30 is for applying the optical film of the present invention to a display device with a touch screen (i.e., a touch panel). The conductive layer 30 is made of at least one of the following materials: ITO, IZO, ATO, and conductive polymer to have a thickness less than 0.1 μm. The ITO, IZO, or ATO can be coated by sputtering or sol-gel while the conductive polymer is coated by wet coating.

FIG. 2b is a schematic sectional view showing the optical film according to a third embodiment. As illustrated, a low-reflection layer 50 (hereinafter, the second low-reflection layer so as to distinguish it from a separate first low-reflection layer described later) is attached to the back surface of the transparent substrate 10. The second low-reflection layer 50 is incorporated to prevent reflection loss due to the light travels from one medium (e.g., the display device) to another (e.g., the transparent substrate 10) with different refractive indices. As such, the refractive index (I_{LR2}) of the second low-reflection layer 50 should satisfy the equation: I_{LR1}≦I_{SUB}-0.05. The second low-reflection layer 50 is made of radiation curable or thermosetting acrylate resin containing at least 0.01˜10% polyoxetane polymers with pendant side chain having 1 to 18 carbon atoms and at least a fluorocarbon (C—F) bond. The resin also contains at least one of 10% of fluoroalkyl acrylate polymer with 20˜60% fluorine, siloxane polymer with 20˜60% silicon, and silica nano particles which can be hollow in structure or surface treated with fluorine or silica/polymer coupling agents, so that the back surface of the second low-reflection layer 50 has a surface energy (E_{LR2-B}) satisfying the equation: E_{LR2-B}≦E_{SUB-B}-5 dyne/cm. The second low-reflection layer 50 is formed by wet coating up to a thickness (T_{LR2}) of 0.01˜1 μm which is a multiple integral of ¼λ of the reflection light and satisfies the equation: 0.001 T_{HCl}≦T_{LR2}≦T_{HCl}. As such and according to experiment, the anti reflection performance of the present embodiment can reach 0.2% with over 300 nm wavelength coverage. FIG. 2c is an extension of the embodiment shown in FIG. 2b to a touch panel. As illustrated, a same conductive layer 30 as the one shown in FIG. 2a is attached to the back surface of the second low-reflection layer 50.

Newton Ring is an optical phenomenon when two optical devices are close together to produce rainbow like interference fringe pattern. To prevent the Newton Rings from being developed between the multi-layer optical film of the present invention and the display device, another hard coat layer 70 (hereinafter, the second hard coat layer) with anti-Newton Ring function is formed on the back surface of transparent substrate 10, which has random roughness over the back surface of the second hard coat layer 70 to reduce the undesirable interference phenomena. The second hard coat layer 70 is made of radiation curable or thermosetting acrylate resin containing at least 1˜20% micro particles of 0.1˜10 μm in diameter so as to achieve an average surface roughness (Ry_{HC2-B}) of 0.1˜5 μm on the back surface. In an alternative embodiment, the radiation curable or thermosetting acrylate resin contains a number of micro particles of 0.1˜10 μm in diameter protruding from the back surface (D_{HC2-B}) in a 1-mm² area so as to satisfy the equation: 0.1×H_{HC2}×G_{HC2}≦D_{HC2-B}≦100×H_{HC2}×G_{HC2}. The particles are preferred to be transparent polymers or glass-typed particles, such as PS, PMMA, silica, etc. The second hard coat layer 70 is formed by wet coating up to a thickness (T_{HC2}) of 0.1˜10 μm satisfying the equation: 0.0005 T_{SUB}≦T_{HC2}≦0.1 T_{SUB}. In addition, the second hard coat layer 70 should have a surface energy (E_{HC2-B}) of 20˜50 dyne/cm on the back surface and an appropriate refractive index (I_{HC2}).

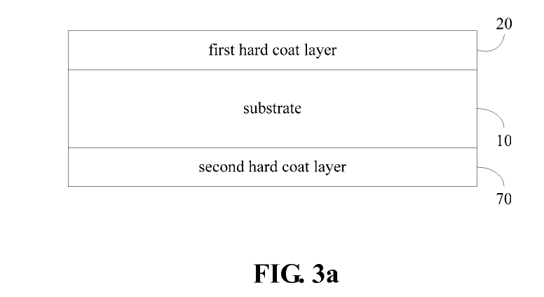

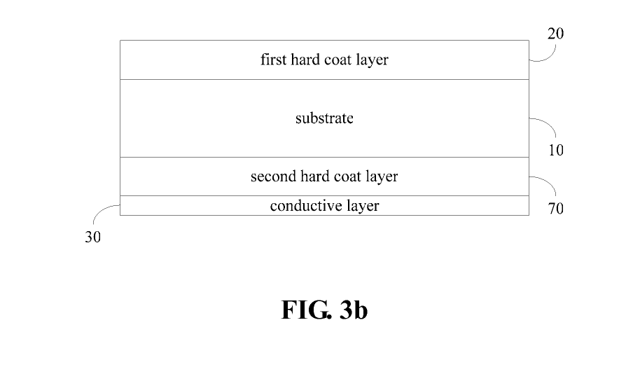

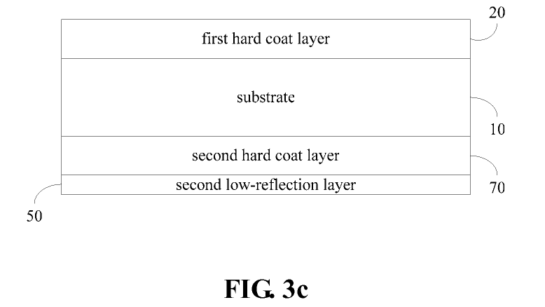

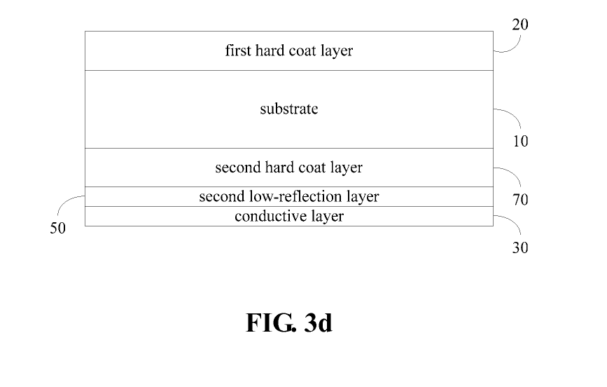

FIGS. 3b˜3d are additional embodiments of the present invention, which are similar to those shown in FIG. 2a˜2c except that the conductive layer 30, the second low-reflection layer 50 are attached to the second hard coat layer 70, instead of the transparent substrate 10. Other than that, the characteristics of the conductive layer 30 and the second low-reflection layer 50 in these embodiments are identical except those described in the following. As illustrated in FIGS. 3b and 3d, the conductive layer 30 is formed on the back surface of the second hard coat layer 70 and the second low-reflection layer 50, respectively, for touch panel applications. As illustrated in FIG. 3c, the refractive index (I_{LR2}), the thickness (T_{LR2}), and the surface energy (E_{LR2-B}) on the back surface of the second low-reflection layer 50 should satisfy the following equations:

I_{LR2}≦I_{HC2}-0.05,

0.001 T_{HC2}≦T_{LR2}≦T_{HC2}, and

E_{LR2-B}≦E_{HC2-B}-5 dyne/cm.

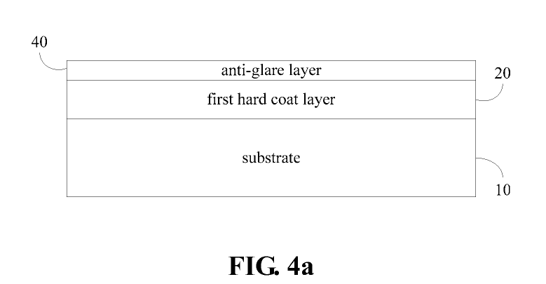

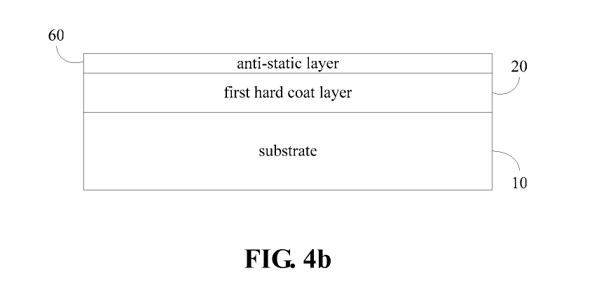

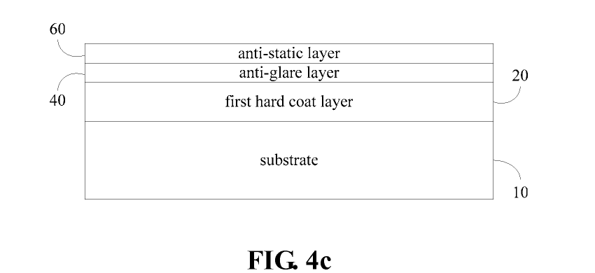

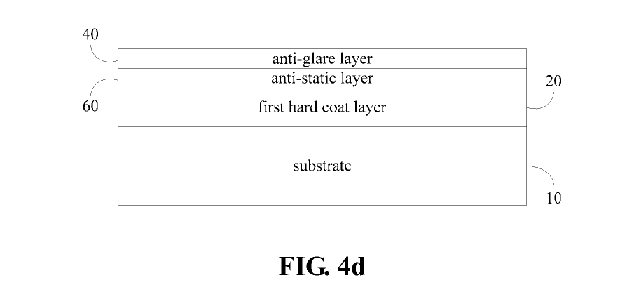

FIG. 4a˜4d are schematic sectional views showing the optical films according to additional alternative embodiments of the present invention. The major characteristic of this set of embodiments is that multiple enhancement functions are integrated into separate layers on the front surface of the first hard coat layer 20, instead of directly into the first hard coat layer 20. As illustrated in FIG. 4a, an anti-glare layer 40 is formed on the front surface of the first hard coat layer 20. The first hard coat layer 20 provides the basic anti-scratch function with its hardness, but does not offer other enhancement functions. The first hard coat layer 20, as described earlier, is made of radiation curable or thermosetting acrylate resin containing at least 0.001˜10% polyoxetane polymers with pendant side chain having 1 to 18, preferably 1 to 4, carbon atoms and at least a fluorocarbon (C—F) bond, 30-60% triacrylate monomer, 30-60% urethane acrylate oligomer, and 0.1˜5% photo initiator. All these chemicals are combined to achieve a surface energy (E_{HCl—F}) of 10-50 dyne/cm on the front surface and a refractive index (I_{HCl}) of 1.4˜1.7. The thickness (T_{HCl}) of the first hard coat layer 20 is between 0.1˜10 μm and should satisfy the equation: 0.0005 T_{SUB}≦T_{HCl}≦0.1T_{SUB}.

The anti-glare layer 40 is made of radiation curable or thermosetting acrylate resin containing at least 1˜40% micro particles of 0.1˜10 μm in diameter so as to achieve an average surface roughness (Ry_{AG-F}) of 0.1˜5 μm on the front surface. In an alternative embodiment, the radiation curable or thermosetting acrylate resin contains a number of micro particles of 0.1˜10 μm in diameter protruding from the front surface (D_{AG-F}) in a 1-mm² area so as to satisfy the equation: 0.1×H_{AG}×G_{AG}≦D_{AG-F}≦100×H_{AG}×G_{AG}, where H_{AG} is the haze in percentage and G_{AG} is the gloss at 60° in GU of the anti-glare layer 40. The anti-glare layer 40 is formed by wet coating up to a thickness (TAG) of 0.05˜10 μm satisfying the equation: 0.05 T_{HCl}≦T_{AG}≦5T_{HCl}. The anti-glare layer 40 has an appropriate surface energy (E_{AG-F}) on the front surface.

Similar to the integration of multiple enhancement functions into the first hard coat layer 20, the anti-smudge function, the anti-UV, and the anti-static function can be integrated individually or together into the anti-glare layer 40 as well. For example, the resin for the anti-glare layer 40 can further contain at least 0.1˜10% siloxane polymer and polyoxetane polymers so as to reduce the surface energy (E_{AG-F}) of the anti-glare layer 40 for at least 5 dyne/cm for anti-smudge function. Alternatively, the resin for the anti-glare layer 40 can further contain 0.01˜5% of one or more types of UV absorbers such as oxalanilide derivatives, benzotriazole derivatives, benzophenone derivatives, triazine derivatives, TiO₂, Al₂O₃, and ZnO for anti-UV function. Again, for integrating anti-static function, the resin for the anti-glare layer 40 can further contain 1˜30% of at least one of a conductive polymer and a conductive inorganic element.

As illustrated in FIG. 4b, a separate anti-static layer 60 is disposed on the front surface of the basic, anti-scratch first hard coat layer 20. The anti-static layer 60 is made of radiation curable or thermosetting acrylate resin containing 1˜30% of at least a conductive polymer and a conductive inorganic element such as ITO, IZO, and ATO. As illustrated in FIGS. 4c and 4d, separate anti-glare layer 40 and anti-static layer 60 can be positioned interchangeably on the front surface of the first hard coat layer 20. Please note that, for the embodiment of FIG. 4d where the anti-glare layer 40 is on the front surface of the anti-static layer 60, the anti-glare layer 40 should satisfy the same thickness requirements when it is directly on the front surface of the first hard coat layer 20: 0.05 T_{HCl}≦T_{AG}≦5T_{HCl}.

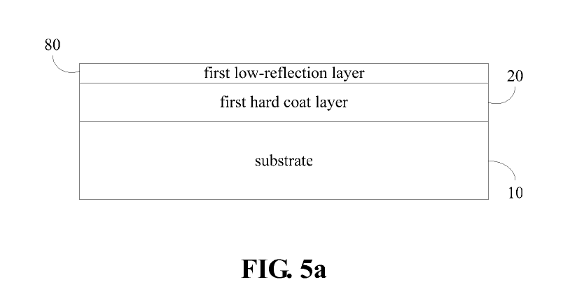

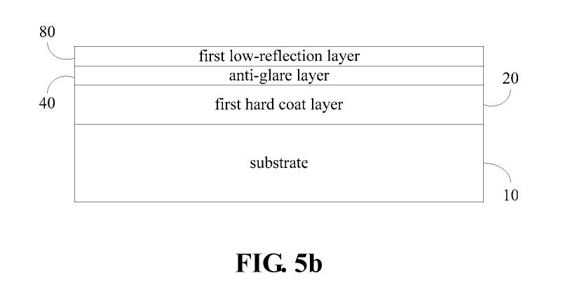

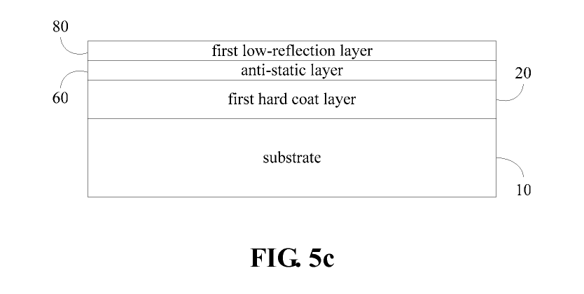

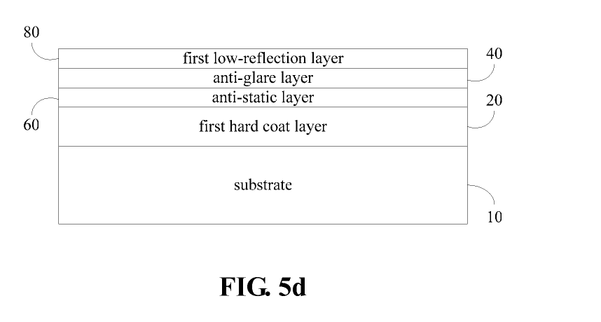

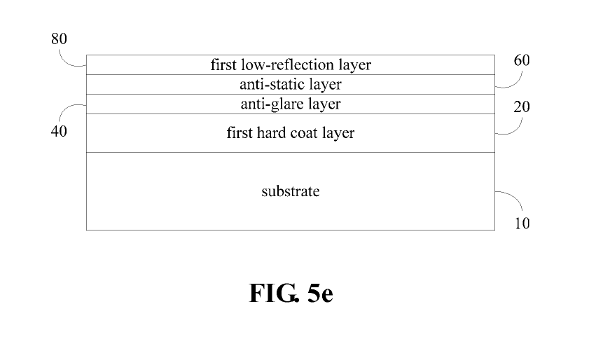

FIG. 5a˜5e are schematic sectional views showing the optical films having a low-reflection layer as the topmost layer to enhance the anti-reflection performance of the optical films. As shown in FIG. 5a, a low-reflection layer 80 (hereinafter, the first low reflection layer) is positioned on the front surface of the first hard coat layer 20. The first hard coat layer 20 can be one with the basic anti-scratch function or the one with multiple integrated enhancement functions, both as described above. The first low-reflection layer 80 is made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which can be hollow in structure or surface treated with fluorine or silica/polymer coupling agents, so that the surface energy (E_{LR1-F}) on the front surface satisfies the equation: E_{LR1-F}≦E_{HCl—F}-5, and the refractive index (I_{LR1}) of the first low-reflection layer 80 satisfies the equation: I_{LR1}≦I_{HCl}-0.05. The first low-reflection layer 80 is formed by wet coating up to a thickness (T_{LR1}) of 0.01˜1 μm satisfying the equation: 0.001 T_{HCl}≦T_{LR1}≦T_{HCl}.

The embodiments shown in FIGS. 5b and 5d are extensions of the embodiments of FIGS. 4a and 4d respectively, where the first low-reflection layer 80 is disposed on the front surface of the anti-glare layer 40, which can have multiple integrated enhancement functions as described above. Similar to the previous embodiment where the first low-reflection layer 80 is formed directly on the first hard coat layer 20, the first low-reflection layer 80 of these embodiments should satisfy the following equations:

E_{LR1-F}≦E_{AG-F}-5 dyne/cm,

0.001 T_{HCl}≦T_{LR1}≦T_{HCl}, and

I_{LR1}≦I_{AG}-0.05.

Following the same principle, as shown in FIGS. 5c and 5e, the first low-reflection layer 80 can be formed on the front surface of the separate anti-static layer 60 of FIGS. 4b and 4c as well. Again, a similar set of equations have to be satisfied:

E_{LR1}≦E_{AS′}-5 dyne/cm,

0.001 T_{HCl}≦T_{LR1}≦T_{HCl}, and

I_{LR1}≦I_{HCl}-0.05 (for the embodiment of FIG. 5c ) or

I_{LR1}≦I_{AG}-0.05 (for the embodiment of FIG. 5e )

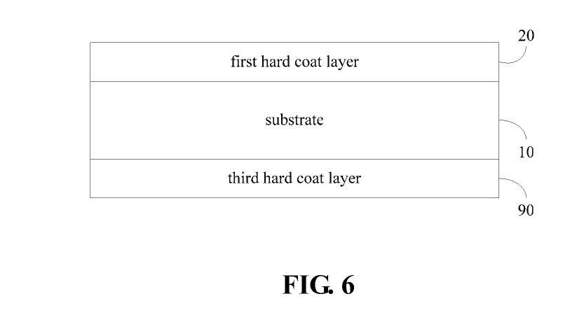

As mentioned earlier in the specification, the optical film of the present invention can also be used in front of the backlight module of a display device to achieve better brightness uniformity. For this application, the first hard coat layer 20 can further contain 1˜40% nano particles of silicon oxide and 1˜70% micro particles of 1˜30 μm in diameter so as to achieve the degree of haze from 1˜99% for integrating the light diffusing function into the first hard coat layer 20. An extension to the foregoing diffusing optical film is shown in FIG. 6, where a third hard coat layer 90 is formed on the back surface of the transparent substrate 10 for integrating the anti-stick function into the optical film. The third hard coat layer 90 is made of radiation curable or thermosetting acrylate resin containing at least 0.01˜10% polyoxetane polymers with pendant side chain having 1 to 18 carbon atoms and at least a fluorocarbon (C—F) bond, and 1˜20% micro particles of 0.1˜10 μm in diameter. The third hard coat layer 90 has a surface energy (E_{HC3-B}) on the back surface of 1˜30 dyne/cm, a thickness (T_{HC3}) of 0.1˜10 μm satisfying the equation: 0.0005 T_{SUB}≦T_{HC3}≦0.1 T_{SUB}.

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A function-enhancing optical film positioned in front a display device, comprising:
a transparent substrate having a front surface, a back surface with a surface energy (E_{SUB-B}), a thickness (T_{SUB}) of 10˜10,000 μm, and a refractive index (I_{SUB}); and
a first hard coat layer having a front surface with a surface energy (E_{HCl˜F}) of 10-50 dyne/cm and a back surface interfacing with said front surface of said transparent substrate, said first hard coat layer having a refractive index (I_{HCl}) of 1.4˜1.7, a haze (H_{HCl}) in percentage, a gloss at 60° (G_{HCl}) in GU, and a thickness (T_{HCl}) of 0.05˜500 μm satisfying the equation: 0.0005 T_{SUB}≦T_{HCl}<0.1 T_{SUB}, said first hard coat layer being made of radiation curable or thermosetting acrylate resin containing at least 0.001˜10% polyoxetane polymers with pendant side chain having 1 to 18 carbon atoms and at least a fluorocarbon (C—F) bond.

2. The function-enhancing optical film according to claim 1, wherein said first hard coat layer further contains 1˜40% nano particles of at least one of silicon oxide and metal oxide for hardness enhancement.

3. The function-enhancing optical film according to claim 1, wherein, for anti-glare function, said first hard coat layer further contains one of the following: (1) 1˜40% micro particles of 0.1˜10 μm in diameter so as to achieve an average surface roughness (Ry_{HCl—F}) of 0.1˜5 μm on said front surface of said first hard coat layer, and (2) a plurality of micro particles of 0.1˜10 μm in diameter such that the number of said micro particles protruding from said front surface in a 1-mm² area (D_{HCl—F}) of said first hard coat layer satisfying the equation:
0.1×H_{HCl}×G_{HCl}≦D_{HCl—F}≦100×H_{HCl}×G_{HCl} for anti-glare function.

4. The function-enhancing optical film according to claim 1, wherein said polyoxetane polymers of said first hard coat layer is at least 0.1% and said first hard coat layer further contains at least 0.01˜10% siloxane polymer so as to reduce said surface energy on said front surface (E_{HCl—F}) for at least 5 dyne/cm for anti-smudge function.

5. The function-enhancing optical film according to claim 1, wherein said first hard coat layer further contains 0.01˜5% of at least an UV absorber selected from oxalanilide derivatives, benzotriazole derivatives, benzophenone derivatives, triazine derivatives, TiO₂, Al₂O₃, and ZnO for anti-UV function.

6. The multi-function optical enhancement film according to claim 1, said first hard coat layer further contains 1˜30% of at least one of a conductive polymer and a conductive inorganic element for anti-static function.

7. The multi-function optical enhancement film according to claim 1, further comprising:
a conductive layer having a front surface, a back surface, and a thickness less than 0.1 μm, said front surface interfacing with said back surface of said transparent substrate, said conductive layer being made of at least one of ITO, IZO, ATO, and conductive polymer.

8. The multi-function optical enhancement film according to claim 1, further comprising:
a second low-reflection layer having a front surface interfacing with said back surface of said transparent substrate, a back surface with a surface energy (E_{LR2-B}) satisfying the equation: E_{LR2-B}≦E_{SUB-B}-5 dyne/cm, a thickness (T_{LR2}) of 0.01˜1 μm satisfying the equation: 0.001 T_{HCl}≦T_{LR2}≦T_{HCl}, and a refractive index (I_{LR2}) satisfying the equation: I_{LR2}≦I_{SUB}-0.05, said second low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

9. The multi-function optical enhancement film according to claim 8, further comprising:
a conductive layer having a front surface, a back surface, and a thickness less than 0.1 μm, said front surface interfacing with said back surface of said second low-reflection layer, said conductive layer being made of at least one of ITO, IZO, ATO, and conductive polymer.

10. The multi-function optical enhancement film according to claim 1, further comprising:
a second hard coat layer for anti-Newton Ring function having a front surface interfacing with said back surface of said transparent substrate, a back surface with a surface energy (E_{HC2-B}) of 20˜50 dyne/cm, a thickness (T_{HC2}) of 0.1˜10 μm satisfying the equation: 0.0005 T_{SUB}≦T_{HC2}≦0.1 T_{SUB}, a refractive index (I_{HC2}), said second hard coat layer being made of radiation curable or thermosetting acrylate resin containing one of the following: (1) at least 1˜20% micro particles of 0.1˜10 μm in diameter so as to achieve an average surface roughness (Ry_{HC2-B}) of 0.1˜5 μm on said back surface, and (2) a plurality of micro particles of 0.1˜10 μm in diameter such that the number of said micro particles protruding from said back surface in a 1-mm² area (D_{HC2-B}) of said second hard coat layer satisfying the e equation: 0.1×H_{HC2}×G_{HC2}≦D_{HC2-B}≦100×H_{HC2}×G_{HC2}, where H_{HC2} is the haze in percentage and G_{HC2} is the gloss at 60° in GU of said second hard coat layer.

11. The multi-function optical enhancement film according to claim 10, further comprising:
a conductive layer having a front surface, a back surface, and a thickness less than 0.1 μm, said front surface interfacing with said back surface of said second hard coat layer, said conductive layer being made of at least one of ITO, IZO, ATO, and conductive polymer.

12. The multi-function optical enhancement film according to claim 10, further comprising:
a second low-reflection layer having a front surface interfacing with said back surface of said second hard coat layer, a back surface with surface energy (E_{LR2-B}) satisfying the equation: E_{LR2-B}≦E_{HC2-B}-5 dyne/cm, a thickness (T_{LR2}) of 0.01˜1 μm satisfying the equation: 0.001T_{HC2}≦T_{LR2}≦T_{HC2}, a refractive index (I_{LR2}) satisfying the equation: I_{LR2}≦I_{HC2}-0.05, said second low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

13. The multi-function optical enhancement film according to claim 12, further comprising:
a conductive layer having a front surface, a back surface, and a thickness less than 0.1 μm, said front surface interfacing with said back surface of said second low-reflection layer, said conductive layer being made of at least one of ITO, IZO, ATO, and conductive polymer.

14. The multi-function optical enhancement film according to claim 1, further comprising:
a first low-reflection layer having a front surface with a surface energy (E_{LR1-F}) satisfying the equation: E_{LR1-F}≦E_{HCl—F}-5 dyne/cm, a back surface interfacing with said front surface of said first hard coat layer, a thickness (T_{LR1}) of 0.01˜1 μm satisfying the equation: 0.001 T_{HCl}≦T_{LR1}≦T_{HCl}, and a refractive index (I_{LR1}) satisfying the equation: I_{LR1}≦I_{HCl}-0.05, said first low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

15. The multi-function optical enhancement film according to claim 1, further comprising:
an anti-glare layer having a front surface with an appropriate surface energy (E_{AG-F}), a back surface interfacing with said front surface of said first hard coat layer, a thickness (T_{AG}) of 0.05˜10 μm satisfying the equation: 0.05 T_{HCl}≦T_{AG}≦5T_{HCl}, said anti-glare layer being made of radiation curable or thermosetting acrylate resin containing one of the following: (1) at least 1˜40% micro particles of 0.1˜10 μm in diameter so as to achieve an average surface roughness (Ry_{AG-F}) of 0.1˜5 μm on said front surface; and (2) a plurality of micro particles of 0.1˜10 μm in diameter such that the number of said micro particles protruding from said front surface in a 1-mm² area (D_{AG-F}) of said anti-glare layer satisfying the equation: 0.1×H_{AG}×G_{AG}≦D_{AG-F}≦100×H_{AG}×G_{AG}, where HAG is the haze in percentage and G_{AG} is the gloss at 60° in GU of said anti-glare layer.

16. The function-enhancing optical film according to claim 15, wherein said anti-glare layer further contains at least 0.1˜10% siloxane polymer and polyoxetane polymer so as to reduce said surface energy (E_{AG-F}) of said front surface for at least 5 dyne/cm for anti-smudge function.

17. The function-enhancing optical film according to claim 15, wherein said anti-glare layer further contains 0.01˜5% of at least an UV absorber selected from oxalanilide derivatives, benzotriazole derivatives, benzophenone derivatives, triazine derivatives, TiO₂, Al₂O₃, and ZnO for anti-UV function.

18. The multi-function optical enhancement film according to claim 15, said anti-glare layer further contains 1˜30% of at least one of a conductive polymer and a conductive inorganic element for anti-static function.

19. The multi-function optical enhancement film according to claim 15, further comprising:
a first low-reflection layer having a front surface with a surface energy (E_{LR1-F}) satisfying the equation: E_{LR1-F}≦E_{AG-F}-5 dyne/cm, a back surface interfacing with said front surface of said anti-glare layer, a thickness (T_{LR1}) of 0.01˜1 μm satisfying the equation: 0.001 T_{HCl}≦T_{LR1}≦T_{HCl}, and a refractive index (I_{LR1}) satisfying the equation: I_{LR1}≦I_{AG}-0.05, said first low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

20. The multi-function optical enhancement film according to claim 15, further comprising:
an anti-static layer having a front surface with a surface energy (E_{AS′-F}), a back surface interfacing with said front surface of said anti-glare layer, and a thickness less than 1 μm, said anti-static layer being made of radiation curable or thermosetting acrylate resin containing 1˜30% of at least one of a conductive polymer and a conductive inorganic element.

21. The multi-function optical enhancement film according to claim 20, further comprising:
a first low-reflection layer having a front surface with a surface energy (E_{LR1-F}) satisfying the equation: E_{LR1-F}≦E_{AS′-F}-5 dyne/cm, a back surface interfacing with said front surface of said anti-static layer, a thickness (T_{LR1}) of 0.01˜1 μm satisfying the equation: 0.001 T_{HCl}≦T_{LR1}≦T_{HCl}, and a refractive index (I_{LR1}) satisfying the equation: I_{LR1}≦I_{AG}-0.05, said first low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

22. The multi-function optical enhancement film according to claim 1, further comprising:
an anti-static layer having a front surface with a surface energy (E_{AS′-F}), a back surface interfacing with said front surface of said first hard coat layer, and a thickness less than 1 μm, said anti-static layer being made of radiation curable or thermosetting acrylate resin containing 1˜30% of at least one of a conductive polymer and a conductive inorganic element.

23. The multi-function optical enhancement film according to claim 22, further comprising:
a first low-reflection layer having a front surface with a surface energy (E_{LR1-F}) satisfying the equation: E_{LR1-F}≦E_{AS′-F}-5 dyne/cm, a back surface interfacing with said front surface of said anti-static layer, a thickness (T_{LR1}) of 0.01˜1 μm satisfying the equation: 0.001 T_{HCl}≦T_{LR1}≦T_{HCl}, and a refractive index (I_{LR1}) satisfying the equation: I_{LR1}≦I_{HCl}-0.05, said first low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

24. The multi-function optical enhancement film according to claim 22, further comprising:
an anti-glare layer having a front surface with an appropriate surface energy (E_{AG-F}), a back surface interfacing with said front surface of said anti-static layer, a thickness (T_{AG}) of 0.05˜10 μm satisfying the equation: 0.05 T_{HCl≦T}_{AG}≦5T_{HCl}, said anti-glare layer being made of radiation curable or thermosetting acrylate resin containing one of the following: (1) at least 1˜40% micro particles of 0.1˜10 μm in diameter so as to achieve an average surface roughness (Ry_{AG-F}) of 0.1˜5 μm on said front surface; and (2) a plurality of micro particles of 0.1˜10 μm in diameter such that the number of said micro particles protruding from said front surface in a 1-mm² area (D_{AG-F}) of said anti-glare layer satisfying the equation: 0.1×H_{AG}×G_{AG}≦D_{AG-F}≦100×H_{AG}×G_{AG}, where HAG is the haze in percentage and G_{AG} is the gloss at 60° in GU of said anti-glare layer.

25. The function-enhancing optical film according to claim 24, wherein said anti-glare layer further contains at least 0.1˜10% siloxane polymer and polyoxetane polymers so as to reduce the surface energy (E_{AG-F}) of said anti-glare layer for at least 5 dyne/cm for anti-smudge function.

26. The function-enhancing optical film according to claim 24, wherein said anti-glare layer further contains 0.01˜5% of at least an UV absorber selected from oxalanilide derivatives, benzotriazole derivatives, benzophenone derivatives, triazine derivatives, TiO₂, Al₂O₃, and ZnO for anti-UV function.

27. The multi-function optical enhancement film according to claim 24, further comprising:
a first low-reflection layer having a front surface with a surface energy (E_{LR1-F}) satisfying the equation: E_{LR1-F}≦E_{AG-F}-5 dyne/cm, a back surface interfacing with said front surface of said anti-glare layer, a thickness (T_{LR1}) of 0.01˜1 μm satisfying the equation: 0.001 T_{HCl}≦T_{LR1}≦T_{HCl}, and a refractive index (I_{LR1}) satisfying the equation: I_{LR1}<I_{AG}-0.05, said first low-reflection layer being made of radiation curable or thermosetting acrylate resin containing at least 0.01˜10% polyoxetane polymers with pendant side chain having 1 to 18 carbon atoms and at least a fluorocarbon (C—F) bond, and at least one of 10% of fluoroalkyl acrylate polymer with 20˜60% fluorine, siloxane polymer with 20˜60% silicon, and silica nano particles which is hollow in structure or surface treated with fluorine or silica/polymer coupling agents.

28. The function-enhancing optical film according to claim 1, wherein said first hard coat layer further contains one of the following: (1) 1˜40% nano particles of silicon oxide and 1˜70% micro particles of 1˜30 μm in diameter so that said haze (H_{HCl}) is between 1˜99% for light diffusing function; and (2) a plurality of nano particles of silicon oxide and a plurality of micro particles of 1˜30 μm in diameter such that the number of said nano and micro particles protruding from said front surface in a 1-mm² area (D_{HCl—F}) of said first hard coat layer satisfying the equation: 0.1×H_{HCl}×G_{HCl}≦D_{HCl—F}<100×H_{HCl}×G_{HCl}.

29. The multi-function optical enhancement film according to claim 28, further comprising:
a third hard coat layer for anti-stick function having a front surface interfacing with said back surface of said transparent substrate, a back surface with a surface energy (E_{HC3-B}) of 1˜30 dyne/cm, a thickness (T_{HC3}) of 0.1˜10 μm satisfying the equation: 0.0005 T_{SUB}≦T_{HC3}≦0.1 T_{SUB}, said third hard coat layer being made of radiation curable or thermosetting acrylate resin containing at least 0.01˜10% polyoxetane polymers with pendant side chain having 1 to 18 carbon atoms and at least a fluorocarbon (C—F) bond.

30. A function-enhancing optical film positioned in front a display device, comprising:
a transparent substrate; and
a first hard coat layer having a front surface and a back surface attached to said transparent substrate, said first hard coat layer being made of radiation curable or thermosetting acrylate resin containing a plurality of micro particles such that the number of said micro particles protruding from said front surface in a 1-mm² area (D_{HCl—F}) of said first hard coat layer satisfying the equation: 0.1×H_{HCl}×G_{HCl}≦D_{HCl—F}≦100×H_{HCl}×G_{HCl} for anti-glare function, where H_{HCl} is the haze in percentage and G_{HCl} is the gloss at 60° in GU of said first hard coat layer.

31. A function-enhancing optical film positioned in front a display device, comprising:
a transparent substrate;
a first hard coat layer attached to said transparent substrate, said first hard coat layer being made of radiation curable or thermosetting acrylate resin; and
an anti-glare layer having a front surface and a back surface attached to said first hard coat layer, said anti-glare layer being made of radiation curable or thermosetting acrylate resin containing a plurality of micro particles such that the number of said micro particles protruding from said front surface in a 1-mm² area (D_{AG-F}) of said anti-glare layer satisfying the equation: 0.1×H_{AG}×G_{AG}≦D_{AG-F}≦100×H_{AG}×G_{AG}, where H_{AG} is the haze in percentage and G_{AG} is the gloss at 60° in GU of said anti-glare layer.
